(19) United States
(12) Patent Application Publication
(10) Pub. No.: US 2011/0010425 A1
(43) Pub. Date: Jan. 13, 2011

(54) TECHNIQUES FOR ENABLING ANONYMOUS INTERACTIVE COMMUNICATION

(75) Inventor: Robert Louis Bernatz, Newport Beach, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: VOXopolis Inc., Newport Beach, CA (US)

(21) Appl. No.: 12/828,037

(22) Filed: Jun. 30, 2010

Related U.S. Application Data
(60) Provisional application No. 61/225,082, filed on Jul. 13, 2009.

(51) Int. Cl. G06F 15/16

(52) U.S. Cl. 709/206

(57) ABSTRACT

Techniques for enabling interactive (e.g., two-way) electronic communication between parties where one party remains anonymous. In one set of embodiments, a system is provided that can store anonymous and non-anonymous identifiers for a group of users. The system can receive, from a first user, an anonymous message addressed from the anonymous identifier of the first user and addressed to the non-anonymous identifier of a second user. The system can then deliver the anonymous message to the second user. The system can further receive, from the second user, a reply message in response to the anonymous message that is addressed from the non-anonymous identifier of the second user and addressed to the anonymous identifier of the first user. The system can then deliver the reply message to the first user. In this manner, the first and second users can communicate interactively while maintaining the anonymity of the first user.

### CROSS-REFERENCES TO RELATED APPLICATIONS

The present application claims the benefit and priority under 35 U.S.C. 119(e) of U.S. Provisional Application No. 61/225,082, filed Jul. 13, 2009 and entitled “A METHOD AND SYSTEM FOR AN ELECTRONIC MECHANISM TO ENABLE ANONYMOUS INTERACTIVE COMMUNICATION,” the entire contents of which are incorporated herein by reference for all purposes.

### BACKGROUND OF THE INVENTION

The present disclosure relates in general to electronic communication, and in particular to techniques for enabling interactive electronic communication between parties where one party remains anonymous.

Anonymous communication can be a powerful tool for helping entities (e.g., individuals, organizations, communities, etc.) garner truthful information, objective facts, and important data about sensitive subjects. In many cases, such information is not openly shared due to fear of retribution or other concerns such as damaging a close personal/professional relationship or disrupting a team/community. By hiding the identity of the information sender from the information recipient, anonymous communication can facilitate information exchange in a manner that is relatively free of recourse or retribution, thereby enabling the participants to reach a new level of efficiency, effectiveness, and knowledge.

One issue with existing electronic tools for facilitating anonymous communication is that such tools generally only support communication in one direction—from the anonymous sender to the known recipient. For example, anonymous remailer services enable a sender to transmit an anonymous email to a recipient (by, e.g., stripping away the sender's “from” address and redirecting the email through an untraceable route), but do not allow the recipient to send a reply email the sender. As another example, web-based survey/comment forms allows parties to provide anonymous feedback on topics addressed on the form, but do not allow the survey administrator to reply to any of the survey participants. Thus, when using these existing tools/services, anonymous senders and known recipients cannot interact in a two-way manner to seek clarification or gain deeper understanding of the discussed topics.

### BRIEF SUMMARY OF THE INVENTION

Embodiments of the present invention provide techniques for enabling interactive (e.g., two-way) electronic communication between parties where one party remains anonymous. In one set of embodiments, a system is provided that can store anonymous and non-anonymous identifiers for a group of users. The system can receive a message from a first user, where the message is addressed from the anonymous identifier of the first user and addressed to the non-anonymous identifier of a second user. The system can then deliver the message to the second user. In various embodiments, the delivered message does not include the non-anonymous identifier of the first user or any other identifying information pertaining to the first user. The system can further receive a reply message from the second user in response to the initial message, where the reply message is addressed from the non-anonymous identifier of the second user and addressed to the anonymous identifier of the first user. The system can then deliver the reply message to the first user. In this manner, the first and second users can communicate interactively while maintaining the anonymity of the first user.

The techniques described herein can provide a number of advantages over prior art anonymous communication/feedback tools. For example, as discussed above, certain embodiments can enable an anonymous sender and a known recipient to conduct a two-way dialogue, rather than limiting communication to a single direction. This dialogue can continue indefinitely until one of the participants breaks off communication, all while keeping the identity of the anonymous sender hidden.

Further, by maintaining an anonymous identifier and non-anonymous identifier for each user, certain embodiments can enable a given user to act as both an anonymous sender (e.g., by sending a message using his/her anonymous identifier) and as a known recipient (e.g., by receiving/soliciting anonymous messages addressed to his/her non-anonymous identifier) in different exchanges.

Further, by ensuring that the anonymous/non-anonymous identifiers assigned to a user are persistent, certain embodiments can enable a known recipient to correlate multiple messages received from a particular anonymous identifier (and thus, a particular individual/entity). This can be useful, for example, if the messages pertain to constructive criticism or performance feedback, since the recipient can determine whether his or her performance is improving (in the view the sender) over time.

The notion of persistent anonymous/non-anonymous identifiers can also enable features such as a rewards program, where a recipient can flag certain anonymous identifiers as providing particularly constructive or useful feedback. The system can then give a reward or gift to the individual/entity associated with the anonymous identifier, while keeping his/or her identity secret from the recipient.

Further, certain embodiments can provide an easily accessible user interface for facilitating the creation and management of anonymous messages. For example, the user interface can be web-based or run on a mobile device. This type of interface can make it convenient for users to send short anonymous messages (e.g., anonymous “microfeedback”) to others on an ad-hoc basis.

According to one embodiment of the present invention, a method is provided that comprises storing, by a computer system, account information for a plurality of users, the account information including anonymous identifiers for a first user and a second user and non-anonymous identifiers for the first user and the second user; receiving, by the computer system, a first message from the first user, the first message being addressed from the anonymous identifier of the first user and being addressed to the non-anonymous identifier of the second user; and delivering, by the computer system, the first message to the second user. The method further comprises receiving, by the computer system, a second message from the second user in response to the first message, the second message being addressed from the non-anonymous identifier of the second user and being addressed to the anonymous identifier of the first user; and delivering, by the computer system, the second message to the first user.

In one embodiment, the delivered first message does not include the non-anonymous identifier of the first user or any other information revealing the identity of the first user.

In one embodiment, the delivered second message does not include the anonymous identifier of the second user.

In one embodiment, the method further comprises receiving a third message from the second user, the third message being addressed from the anonymous identifier of the second user and being addressed to a non-anonymous identifier of a third user; delivering the third message to the third user; receiving a fourth message from the third user in response to the third message, the fourth message being addressed from a non-anonymous identifier of the third user and being addressed to the anonymous identifier of the second user; and delivering the fourth message to the second user.

In one embodiment, delivering the first message to the second user comprises storing the first message in a message inbox maintained by the computer system for the second user, and delivering the second message to the first user comprises storing the second message in a message inbox maintained by the computer system for the first user.

In one embodiment, the method further comprises, subsequently to delivering the first message, transmitting a delivery notification to an email address of the second user, and subsequently to delivering the second message, transmitting a delivery notification to an email address of the first user.

In one embodiment, the method further comprises, prior to receiving the first message from the first user, generating a first user interface for authenticating the first user; authenticating the first user based on information entered into the first user interface; and generating a second user interface for enabling the first user to compose the first message.

In one embodiment, the second user interface includes a user interface control for searching for non-anonymous identifiers of other users. In another embodiment, the second user interface includes a user interface control for selecting a pre-defined message template.

In one embodiment, the method further comprises, subsequently to delivering the first message, generating a third user interface for enabling the first user to verify delivery of the first message.

In one embodiment, the method further comprises, prior to receiving the second message from the second user, generating a fourth user interface for authenticating the second user; authenticating the second user based on information entered into the fourth user interface; generating a fifth user interface for enabling the second user to view messages delivered to the second user; and generating a sixth user interface for enabling the second user to compose the second message in response to the first message.

In one embodiment, the first, second, third, fourth, fifth, and sixth user interfaces are web-based interfaces. In another embodiment, the first, second, third, fourth, fifth, and sixth user interfaces are rendered on a mobile device.

In one embodiment, the anonymous and non-anonymous identifiers of the first user are manually selected by the first user. In another embodiment, the anonymous and non-anonymous identifiers of the first user are automatically determined by the computer system.

In one embodiment, the first message includes one or more of: text, a video clip, an audio clip, and an image.

In one embodiment, the method further comprises generating a plurality of user interfaces for enabling the first user to define a microsite, the microsite including one or more topics and, for each topic, a user interface control for sending an anonymous message regarding the topic to the non-anonymous identifier of the first user.

In one embodiment, the microsite is accessible via a uniform resource locator (URL) that includes a domain name suffix dedicated to anonymous communication (e.g., “.vox”).

In one embodiment, the method further comprises generating JavaScript code for a topic in the one or more topics that is embeddable in a web page, where the JavaScript code is configured to generate a user interface in the web page for enabling users to send an anonymous message regarding the topic to the non-anonymous identifier of the first user.

According to another embodiment of the present invention, a non-transitory machine-readable medium having stored thereon program code executable by a computer system is provided. The program code comprises code that causes the computer system to store account information for a plurality of users, the account information including anonymous identifiers for a first user and a second user and non-anonymous identifiers for the first user and the second user; code that causes the computer system to receive a first message from the first user, the first message being addressed from the anonymous identifier of the first user and being addressed to the non-anonymous identifier of the second user; and code that causes the computer system to deliver the first message to the second user. The program code further comprises code that causes the computer system to receive a second message from the second user in response to the first message, the second message being addressed from the non-anonymous identifier of the second user and being addressed to the anonymous identifier of the first user; and code that causes the computer system to deliver the second message to the first user.

According to another embodiment of the present invention, a system is provided. The system comprises a storage device configured to store account information for a first user and a second user, the account information including anonymous identifiers for the first user and the second user and non-anonymous identifiers for the first user and the second user; and a processor in communication with the storage device. The processor is configured to store account information for a plurality of users, the account information including anonymous identifiers for a first user and a second user and non-anonymous identifiers for the first user and the second user; receive a first message from the first user, the first message being addressed from the anonymous identifier of the first user and being addressed to the non-anonymous identifier of the second user; deliver the first message to the second user. The processor is further configured to receive a second message from the second user in response to the first message, the second message being addressed from the non-anonymous identifier of the second user and being addressed to the anonymous identifier of the first user; and deliver the second message to the first user.

A further understanding of the nature and advantages of the embodiments disclosed herein can be realized by reference to the remaining portions of the specification and the attached drawings.

### BRIEF DESCRIPTION OF THE DRAWINGS

FIG. 1 is a simplified block diagram illustrating a system environment in accordance with an embodiment of the present invention.

FIG. 2 is a simplified block diagram illustrating a computer system in accordance with an embodiment of the present invention.

FIGS. 3A and 3B are flow diagrams illustrating a process for enabling anonymous interactive communication between two users in accordance with an embodiment of the present invention.

FIG. 4 is an example user interface for authentication or registering a user in accordance with a embodiment of the present invention.

FIG. 5 is an example user interface for composing an anonymous message in accordance with an embodiment of the present invention.

FIGS. 6 and 7 are example user interfaces for managing messages in accordance with an embodiment of the present invention.

FIG. 8 is another example user interface for composing an anonymous message in accordance with an embodiment of the present invention.

FIGS. 9-12 are example user interfaces for defining a microsite in accordance with an embodiment of the present invention.

FIG. 13 is an example user interface of a user-defined microsite in accordance with an embodiment of the present invention.

FIGS. 14 and 15 are example user interfaces for defining a message composition widget in accordance with an embodiment of the present invention.

FIG. 16 illustrates example user interfaces for a mobile device in accordance with an embodiment of the present invention.

### DETAILED DESCRIPTION OF THE INVENTION

In the following description, for the purposes of explanation, numerous details are set forth in order to provide an understanding of embodiments of the present invention. It will be apparent, however, to one of ordinary skill in the art that certain embodiments can be practiced without some of these details.

Embodiments of the present invention provide techniques for enabling interactive (e.g., two-way) electronic communication between parties where one party remains anonymous. In one set of embodiments, a system is provided that can store anonymous and non-anonymous identifiers for a group of users. The system can receive a message from a first user, where the message is addressed from the anonymous identifier of the first user and addressed to the non-anonymous identifier of a second user. The system can then deliver the message to the second user. In various embodiments, the delivered message does not include the non-anonymous identifier of the first user or any other identifying information pertaining to the first user. The system can further receive a reply message from the second user in response to the initial message, where the reply message is addressed from the non-anonymous identifier of the second user and addressed to the anonymous identifier of the first user. The system can then deliver the reply message to the first user. In this manner, the first and second users can communicate interactively while maintaining the anonymity of the first user.

The techniques described herein can provide a number of advantages over prior art anonymous communication/feedback tools. For example, as discussed above, certain embodiments can enable an anonymous sender and a known recipient to conduct a two-way dialogue, rather than limiting communication to a single direction. This dialogue can continue indefinitely until one of the participants breaks off communication, all while keeping the identity of the anonymous sender hidden.

Further, by maintaining an anonymous identifier and non-anonymous identifier for each user, certain embodiments can enable a given user to act as both an anonymous sender (e.g., by sending a message using his/her anonymous identifier) and as a known recipient (e.g., by receiving/soliciting anonymous messages addressed to his/her non-anonymous identifier) in different exchanges.

Further, by ensuring that the anonymous/non-anonymous identifiers assigned to a user are persistent, certain embodiments can enable a known recipient to correlate multiple messages received from a particular anonymous identifier (and thus, a particular individual/entity). This can be useful, for example, if the messages pertain to constructive criticism or performance feedback, since the recipient can determine whether his or her performance is improving (in the view the sender) over time.

The notion of persistent anonymous/non-anonymous identifiers can also enable features such as a rewards program, where a recipient can flag certain anonymous identifiers as providing particularly constructive or useful feedback. The system can then give a reward or gift to the individual/entity associated with the anonymous identifier, while keeping his/or her identity secret from the recipient.

Further, certain embodiments can provide an easily accessible user interface for facilitating the creation and management of anonymous messages. For example, the user interface can be web-based or run on a mobile device. This type of interface can make it convenient for users to send short anonymous messages (e.g., anonymous “microfeedback”) to others on an ad-hoc basis.

Other features and advantages will become apparent in view of the following description.

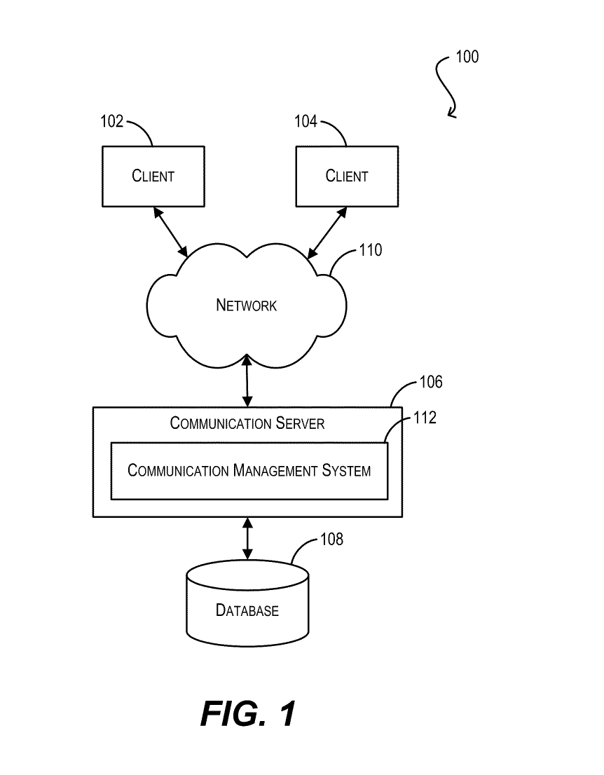

FIG. 1 is a simplified block diagram of a system environment 100 in accordance with an embodiment of the present invention. As shown, system environment 100 includes clients 102, 104, a communication server 106, and a database 108 communicatively coupled via a network 110. Although FIG. 1 depicts two clients, one server, and one database, any number of clients, servers, and databases can be supported.

Clients 102, 104 are configured to execute a client-side program (e.g., a Web browser, propriety client application, etc.) for interacting with communication server 106. Clients 102, 104 can be general purpose computers, such as desktop or laptop computers running a version of Microsoft Windows, Apple OS X, or another consumer operating system. Clients 102, 104 can also be any other type of electronic device (e.g., a smart phone, PDA, tablet, netbook, or the like) that is capable of communicating over a network and interacting with server 106.

Communication server 106 is configured to run a server-side application, such as communication management system 112, for enabling interactive anonymous communication among a group of users (e.g., users of clients 102, 104). In certain embodiments, communication server 106 can be part of a scalable server cloud. Like clients 102, 104, communication server 106 can be a general purpose computer that runs any of a variety of consumer operating systems. Server 106 can also be a specialized server computer, such as a rack-mounted server, that is configured to run a server-oriented operating system (e.g., Solaris, FreeBSD, Linux, etc.).

Communication management system 112 can be a software and/or hardware based component of server 106 and can provide various services for facilitating interactive anonymous communication. In one set of embodiments, communication management system 112 can maintain account information for a group of registered users, where the account information includes, inter alia, an anonymous identifier, a non-anonymous identifier, an email address, and a password for each user. Based on this account information, communication management system 112 can enable two or more users to communicate in an interactive (e.g., two-way) manner, while maintaining the anonymity of one user.

For example, a first user can login to system 112 (e.g., via client 102) using his/her non-anonymous identifier and password and access a message composition user interface for composing an anonymous message addressed to the non-anonymous identifier of a second user. System 112 can then automatically route and store the message so that it is accessible by the second user. In various embodiments, the routed message only identifies the sender by his/her anonymous identifier; the message does not include the sender's non-anonymous identifier or any other identifying information, thereby preserving his/her anonymity.

The second user can then login to system 112 (e.g., via client 104) using his/her non-anonymous identifier and password and access a message management interface for managing the messages he/she has received or sent. Through this interface, the second user can view the anonymous message received from the first user. The second user can further access a message composition interface for composing a reply message addressed to the anonymous identifier of the first user. System 112 can then automatically route and store the reply message so that it is accessible to the first user. In this manner, the first and second users can communicate back and forth via system 112 while keeping the first user's identity hidden. The specific processing performed by communication management system 112 is described in further detail below.

In one set of embodiments, communication management system 112 can be implemented as a web-based application. In these embodiments, system 112 can include or interoperate with a web server module, such as Apache, and clients 102, 104 can communicate with system 112 via HyperText Transfer Protocol (HTTP). In a particular embodiment, clients 102, 104 can access communication management system 112 via a Uniform Resource Identifier (URL) that includes a sponsored top-level domain (e.g., “.vox”) dedicated to anonymous communication.

In another set of embodiments, communication management system 112 can be implemented as a server application for mobile devices (e.g., smartphones, tablets, etc.). In these embodiments, clients 102, 104 can access communication management system 112 via either a public or proprietary protocol.

Data managed by communication management system 112 (e.g., user account information, user-generated messages, etc.) can be stored in a data store such as database 108. In FIG. 1, database 108 is shown as being remote from server 106. For example, database 108 can reside in a storage-area network (SAN) familiar to those skilled in the art. Alternatively, database 108 can reside on a storage medium local to (or resident in) server 106. Database 108 can be implemented using any of a number of commercially available database systems, including those available from Oracle, Microsoft, Sybase, and IBM. In a particular embodiment, database 108 can be a relational database that is adapted to store, update, and retrieve data in response to SQL-formatted commands.

Network 110 can be any type of data communications network such as a local area network (LAN), a wide-area network (WAN), a virtual network (e.g., VPN), or the Internet. In certain embodiments, the various components of system architecture 100 can communicate over different types of networks. For example, in one embodiment clients 102, 104 can communicate with server 106 via the Internet, and server 106 can communicate with database 108 via a secure, local area network.

It should be appreciated that system environment 100 of FIG. 1 is illustrative and not intended to limit embodiments of the present invention. For example, the various entities depicted in FIG. 1 can have other capabilities or include other components that are not specifically described. One of ordinary skill in the art will recognize other variations, modifications, and alternatives.

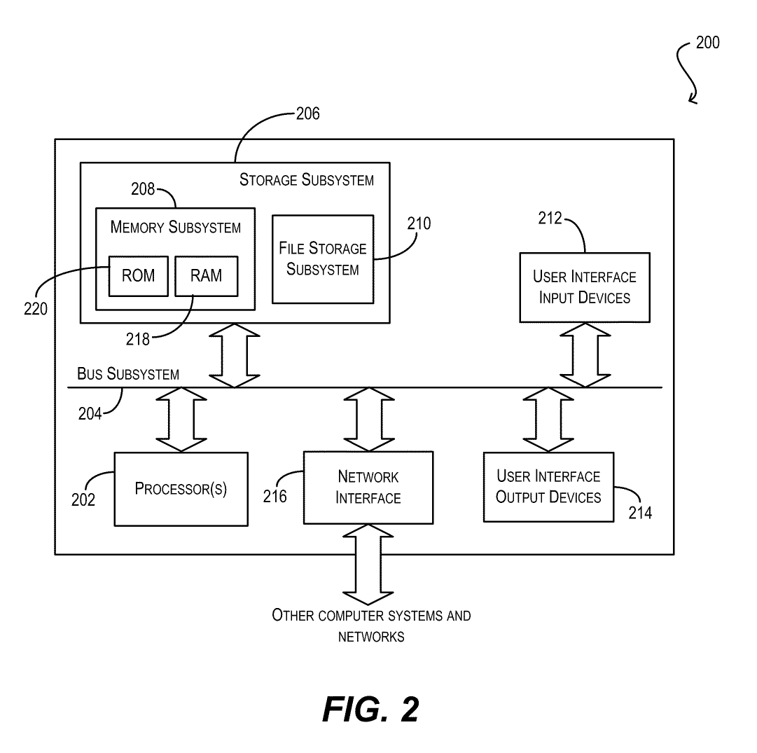

FIG. 2 is a simplified block diagram of a computer system 200 in accordance with an embodiment of the present invention. Computer system 200 can be used to implement any of the clients or servers 102, 104, 106 illustrated in FIG. 1. As shown in FIG. 2, computer system 200 can include one or more processors 202 that communicate with a number of peripheral devices via a bus subsystem 204. These peripheral devices can include a storage subsystem 206 (comprising a memory subsystem 208 and a file storage subsystem 210), user interface input devices 212, user interface output devices 214, and a network interface subsystem 216.

Bus subsystem 204 can provide a mechanism for letting the various components and subsystems of computer system 200 communicate with each other as intended. Although bus subsystem 204 is shown schematically as a single bus, alternative embodiments of the bus subsystem can utilize multiple busses.

Network interface subsystem 216 can serve as an interface for communicating data between computer system 200 and other computer systems or networks (e.g., network 110 of FIG. 1). Embodiments of network interface subsystem 216 can include an Ethernet card, a modem (telephone, satellite, cable, ISDN, etc.), digital subscriber line (DSL) units, and the like.

User interface input devices 212 can include a keyboard, pointing devices (e.g., mouse, trackball, touchpad, etc.), a scanner, a barcode scanner, a touch-screen incorporated into a display, audio input devices (e.g., voice recognition systems, microphones, etc.) and other types of input devices. In general, use of the term “input device” is intended to include all possible types of devices and mechanisms for inputting information into computer system 200.

User interface output devices 214 can include a display subsystem, a printer, a fax machine, or non-visual displays such as audio output devices, etc. The display subsystem can be a cathode ray tube (CRT), a flat-panel device such as a liquid crystal display (LCD), or a projection device. In general, use of the term “output device” is intended to include all possible types of devices and mechanisms for outputting information from computer system 200.

Storage subsystem 206 can include a memory subsystem 208 and a file/disk storage subsystem 210. Subsystems 208 and 210 represent computer-readable storage media that can store program code and/or data that provide the functionality of the present invention.

Memory subsystem 208 can include a number of memories including a main random access memory (RAM) 218 for storage of instructions and data during program execution and a read-only memory (ROM) 220 in which fixed instructions are stored. File storage subsystem 210 can provide persistent (i.e., non-volatile) storage for program and data files, and can include a magnetic or solid-state hard disk drive, a floppy disk drive along with associated removable media, an optical drive along with associated removable media (e.g., CD-ROM, DVD, Blu-Ray, etc.), a removable flash memory-based drive or card, and/or other types of storage media known in the art.

It is should be appreciated that computer system 200 is illustrative and not intended to limit embodiments of the present invention. Many other configurations having more or fewer components than system 200 are possible.

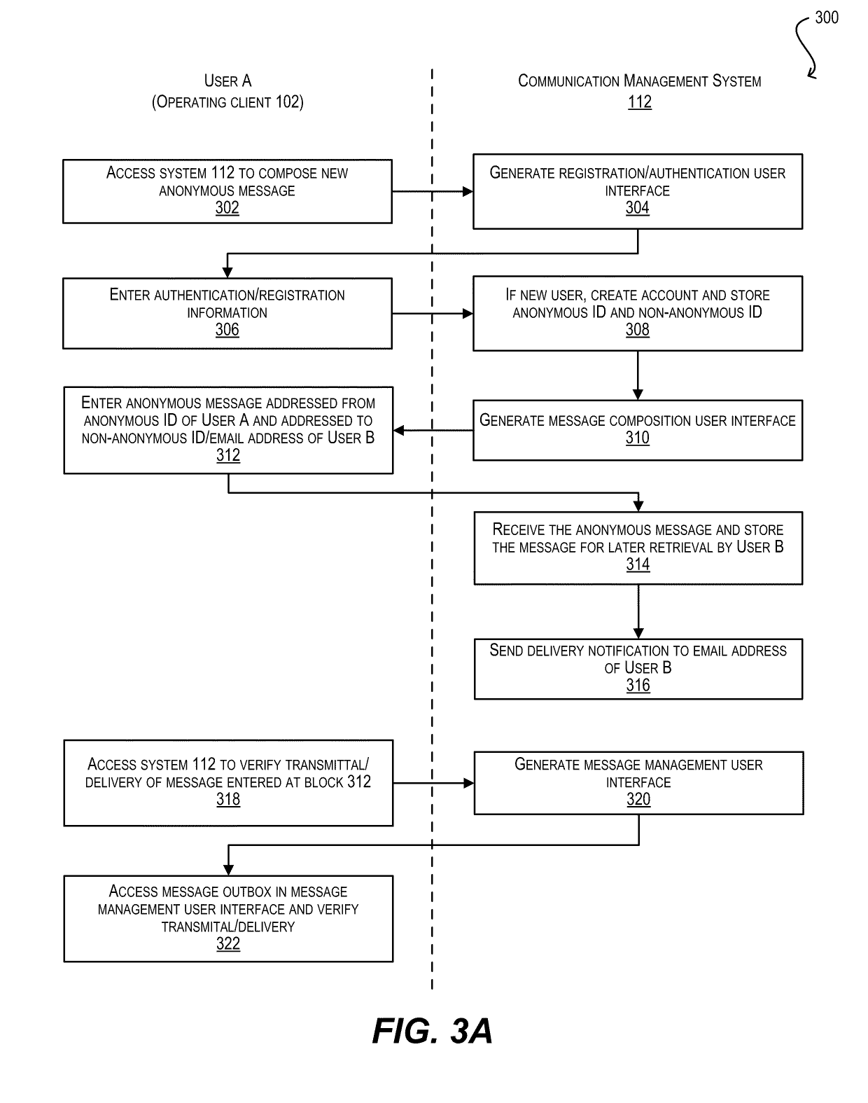

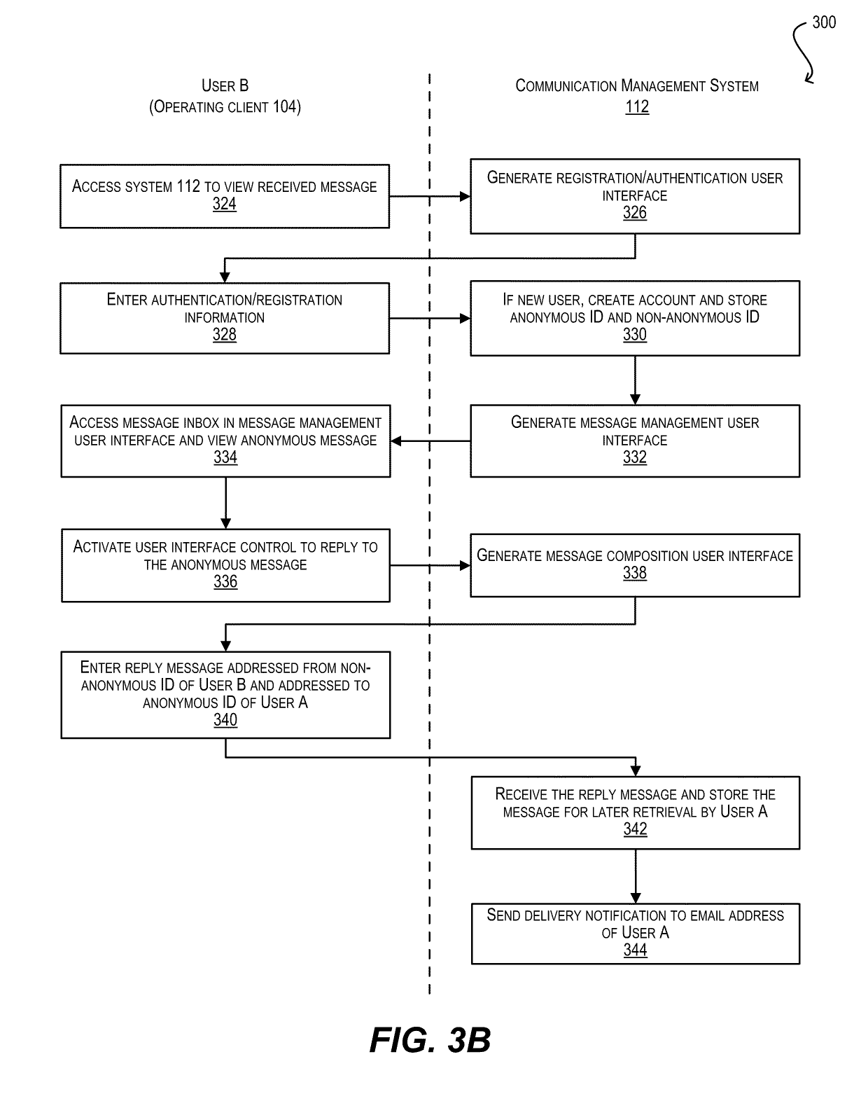

FIGS. 3A and 3B are flow diagrams illustrating a process 300 for enabling anonymous interactive communication between two users via communication management system 112 of FIG. 1 according to an embodiment of the present invention. In particular, FIG. 3A illustrates interactions between an anonymous sender (“user A”) and communication management system 112 that enable the anonymous sender to send an anonymous message to a known recipient (“user B”). FIG. 3B illustrates interactions between user B and communication management system 112 that enable user B to view the anonymous message and send a reply message to user A, while maintaining the anonymity of user A. In one set of embodiments, user A can interact with communication management system 112 via client 102 of FIG. 1, and user B can interact with communication management system 112 via client 104 of FIG. 1.

The various steps of process 300 can be implemented in software, hardware, or a combination thereof. As software, process 300 can be encoded as program code stored on a non-transitory, machine-readable storage medium.

At block 302, user A can electronically access communication management system 112 with the intent of composing and sending an anonymous message to user B. For example, if system 112 is implemented as a web-based application, user A can access system 112 by opening an web browser and navigating to the URL assigned to system 112. If system 112 is implemented as a server application for mobile devices, user A can access system 112 by launching a client application on his/her mobile device.

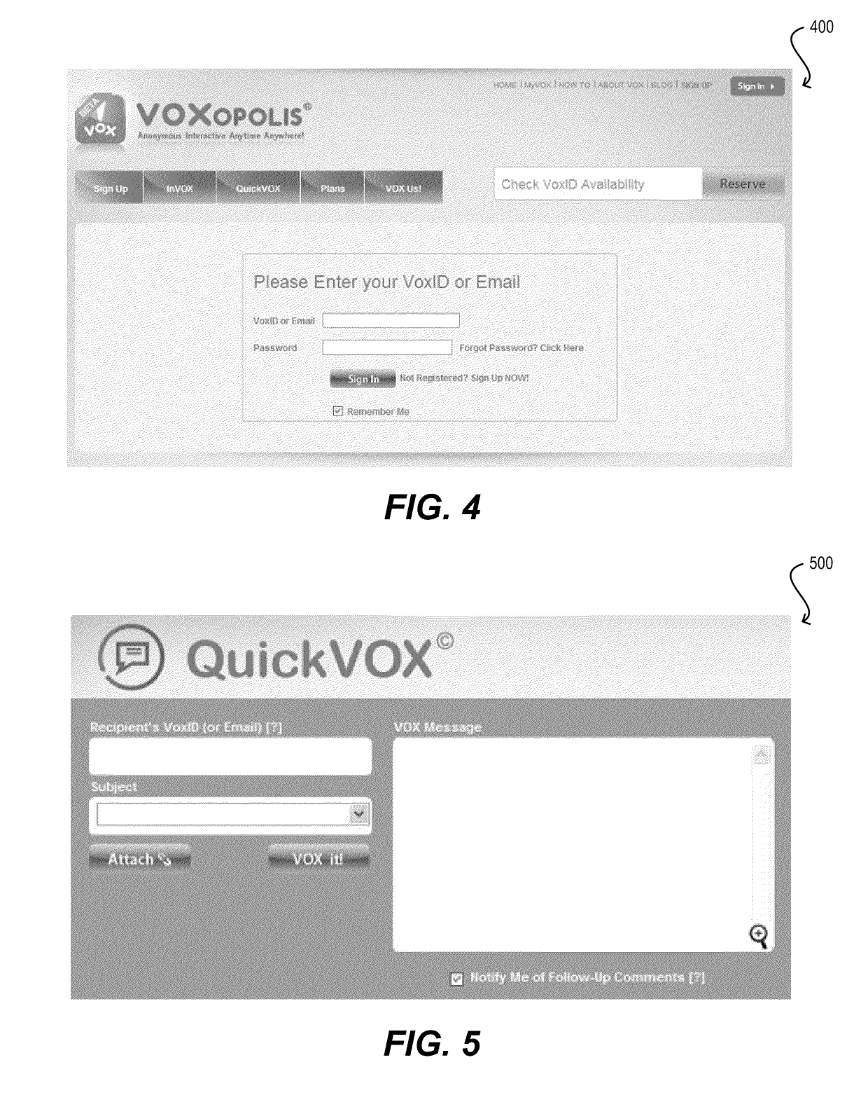

At block 304, system 112 can generate a registration and/or authentication user interface. For example, if user A is already registered with system 112, system 112 can prompt user A to enter his/her non-anonymous identifier (or email address) and password that is stored by the system. The system can then authenticate the user based on the entered credentials. FIG. 4 illustrates an example authentication interface 400 that includes fields for a “VoxID” (i.e., non-anonymous identifier) and a password.

If user A has not previously registered with system 112, system 112 can prompt user A to enter registration information such as name, email address, password, and the like. System 112 can then create a new account for user A based on the entered registration information and store an anonymous identifier and a non-anonymous identifier for the user (blocks 306, 308). As discussed in detail below, these identifiers can be used by the system to facilitate anonymous communication with others. In particular, the anonymous identifier can be used as an alias for the user when sending anonymous messages, thereby preserving his/her identity. The non-anonymous identifier can be made public to other users of the system so that they can send anonymous messages to the user via the non-anonymous identifier.

In one set of embodiments, system 112 can automatically generate the anonymous and non-anonymous identifiers for a user upon registration. For example, system 112 can assign a random or pseudo-random sequence of alphanumeric characters as the user's anonymous identifier, and assign the user's name or email address as the user's non-anonymous identifier. In other embodiments, the user can select his/her own anonymous and/or non-anonymous identifiers as part of the registration process. In certain embodiments, once non-anonymous and anonymous identifiers are assigned to a user, they are persistent for all message exchanges. This allows, for example, recipients to correlate multiple messages received from the same anonymous sender.

Once user A has been authenticated/registered, system 112 can generate a message composition user interface for composing a new anonymous message (block 310). This user interface can be similar to message composition screens used in typical email programs, or can be any form of interface that allows for the capture of textual and/or non-textual data. User A can then enter a new message that is addressed from his/her anonymous identifier and addressed to the non-anonymous identifier (or email address) of user B via the interface (block 312).

FIG. 5 illustrates an example message composition interface 500. As shown, interface 500 can include a field for specifying the non-anonymous identifier (or email address) of the recipient, a field for providing a subject, and a field for entering a text message (“VOX message”). In one set of embodiments, the subject field can be a poplist that includes a number of selectable subject lines associated with predefined message templates. Upon selection of a particular subject line, the “VOX message” field can be populated with the content of the associated template, thereby providing a shortcut to the user if he/she tends to compose many messages pertaining to a specific subject/topic.

Interface 500 can also include an “Attach” button for attaching documents/elements to the anonymous message. Examples of such documents can include, e.g., audio clips, video clips, images, and the like.

In some cases, the sender may not know the non-anonymous identifier that has been registered for the intended recipient. Accordingly, interface 500 can also include a user interface element for searching for non-anonymous identifiers in the system (not shown). The search can be based on a user's name, email address, or any other identifying criteria.

Once user A has entered his/her message via the message composition interface, the message can be received by system 112 and routed/stored for later retrieval by user B (block 314). As discussed below, this can entail storing the message in a message inbox assigned to user B. In various embodiments, the stored message does not include the non-anonymous identifier of user A or any other information that would reveal the identity of user A. Accordingly, the identity of the sender (user A) is kept hidden from user B.

In some embodiments, system 112 can send a delivery notification to an email address of user B to notify the user that a new anonymous message has been received (block 316). In a particular embodiment, the notification email can include a hypertext link or other mechanism to navigate directly to system 112 and view the message. Alternatively, system 112 can send a delivery notification to user B via other means (e.g., SMS text message, automated voice call, instant messenger message, etc.).

Once the anonymous message has been sent, user A can access system 112 to verify that the message as been properly transmitted/delivered to user B (block 318). In particular, user A can access a message management user interface that provides a central location for viewing all of the messages sent and received by a particular user (block 320). In one set of embodiments, this message management user interface can be similar to a typical email program user interface, with a message inbox, a message outbox, and the like. In these embodiments, user A can navigate to his/her message outbox to determine whether a copy of the sent message is stored there (block 322). If a copy is in user A's message outbox, that can provide an indication that the message has been properly captured and routed by system 112.

Turning now to FIG. 3B, user B can access system 112 to view the anonymous message sent by user A (block 324). Like blocks 304-308 of FIG. 3A, user B can either provide authentication credentials (if he/she is an existing user) or registration information (if he/she is a new user) to system 112 (blocks 326-330). Once user B is authenticated or registered, he/she can navigate to a message management user interface generated by the system (block 332). In various embodiments, this message management interface can be similar to the one described with respect to blocks 318-322, and can include a message inbox, a message outbox, and the like.

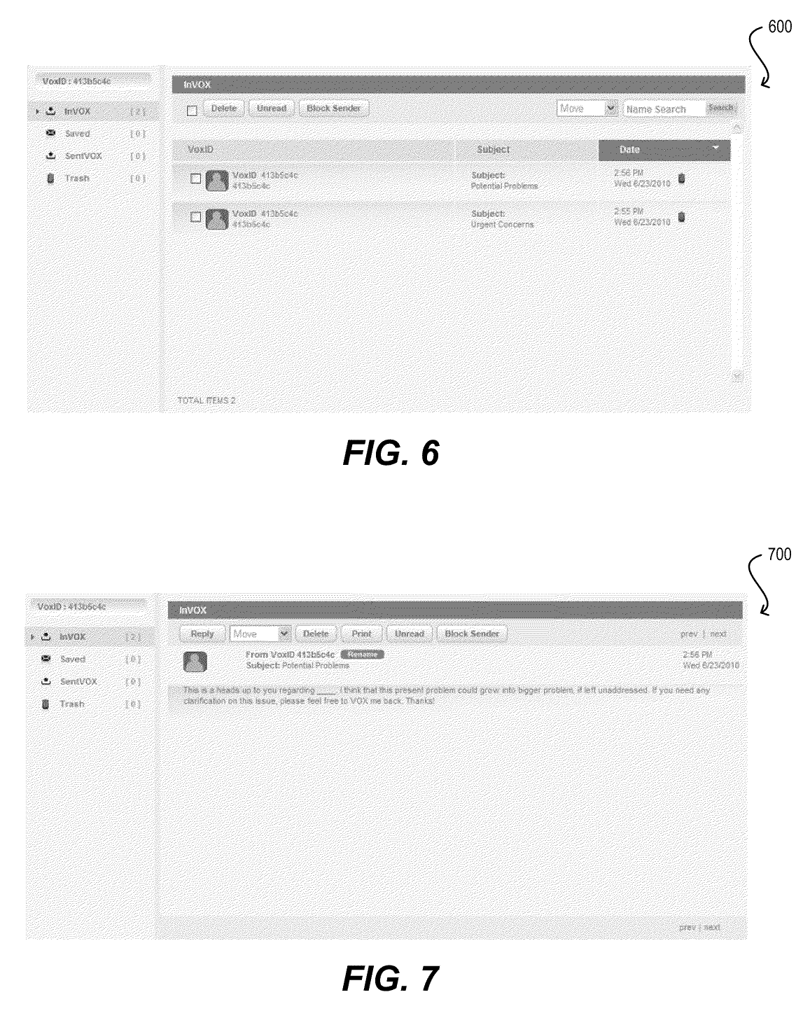

At block 334, user B can access his/her message inbox and view the received message. FIGS. 6 and 7 illustrate user interfaces that show an exemplary view of the message inbox and a exemplary view of a received message (600 and 700 respectively). As can be seen in interface 700, the message displayed to the recipient only identifies the anonymous identifier of the sender (in this case, “413b5c4c”); the message does not include any other information that may reveal the identity of the sender.

In one set of embodiments, the recipient can rename the anonymous identifier of the sender via the “rename” button. This enables the recipient to organize messages from a particular anonymous sender using an alias that can be easily remembered (or that otherwise has some significance to the recipient). Once a particular anonymous identifier has been renamed in this manner, all messages received from that anonymous identifier will appear as being addressed from the new alias, and all messages sent to that anonymous identifier will appear as being addressed to the new alias.

After user B has viewed the received message, user B can activate a user interface control for replying to the message (see the “reply” button in interface 700). In response, system 112 can generate a message composition user interface similar to the interface described with respect to block 310. In this case, the message composition user interface can be pre-populated such that the “recipient” field is the anonymous identifier of user A. The interface can also include the content of the original message received from user A in the “VOX Message” field (for quotation purposes).

At block 340, user B can enter his/her reply message via the message composition user interface, which is captured by system 112 and stored for later retrieval by user A (block 342). In various embodiments, the stored message is addressed from the non-anonymous identifier of user B, but does not include the anonymous identifier of user B. System 112 can subsequently send a delivery notification via email (or other means) to user A to notify the user that a new message has been received (block 344).

In this manner, user A and user B can engage in a two-way dialogue via system 112. For example, although not shown, user A can send a response to the reply message of user B, and this interactive communication can continue in perpetuity until one of the parties breaks off communication. Throughout this process, the true identity of user A remains hidden.

It should be appreciated that user B, which is the “known recipient” of the original anonymous message in process 300, can also initiate and send anonymous messages to other users of system 112, including user A. For example, user B can access the message composition user interface and draft a message addressed from the anonymous identifier of user B and addressed to the non-anonymous identifier or email address of another user. Thus, users of system 112 can act as both “known recipients” or “anonymous senders” in an anonymous communication interaction.

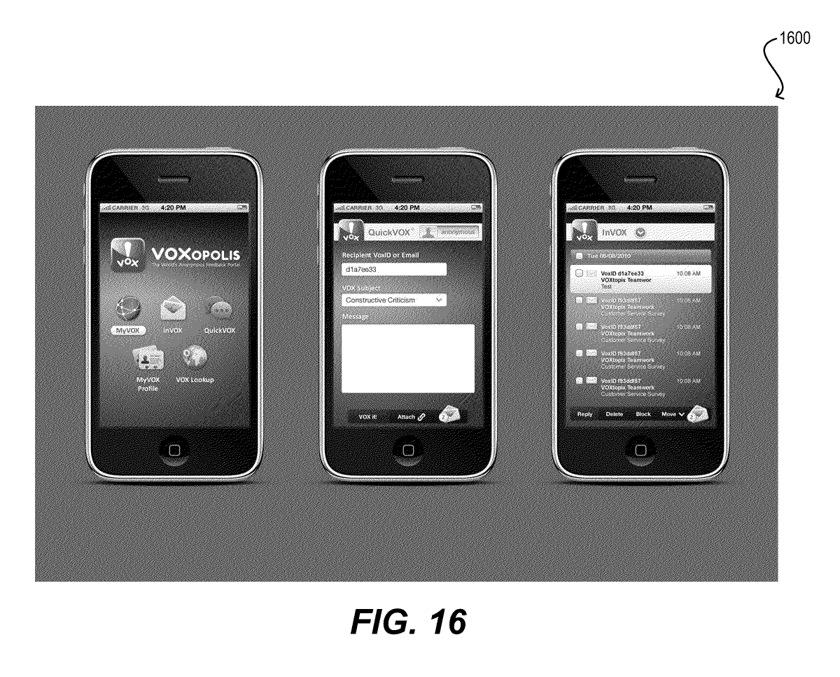

Further, it should be appreciated that process 300 is illustrative and that variations and modifications are possible. For example, in one set of embodiments the user interfaces generated by system 112 as part of process 300 can be rendered on a mobile device (e.g., smartphone, tablet, etc.) rather than on a standard desktop or laptop computer. FIG. 16 illustrates mobile versions 1600 of user interfaces for composing a new anonymous message and for viewing a user's message inbox.

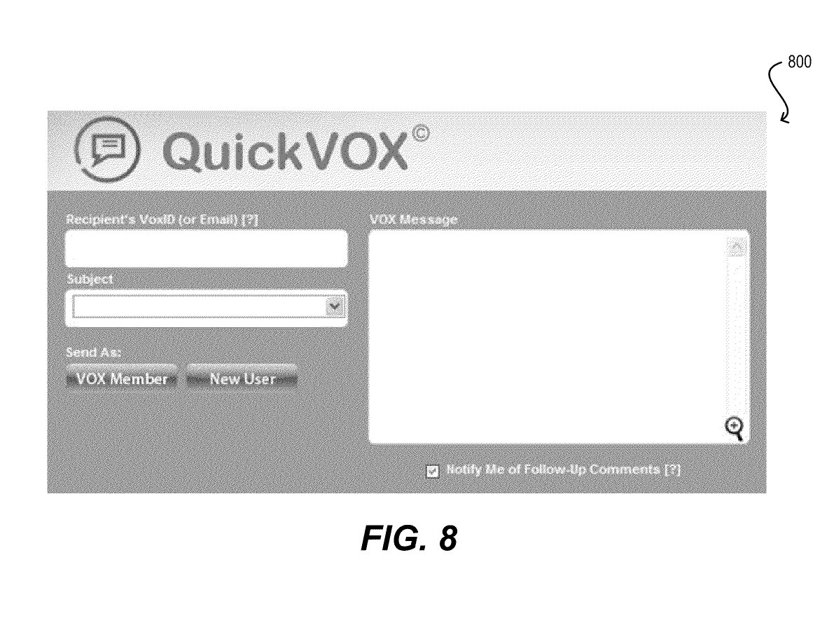

As another example, although process 300 indicates that user A must login/register prior to composing an anonymous message, in certain embodiments user A can compose the message without being authenticated or registered by the system. FIG. 8 illustrates an example message composition user interface 800 that includes buttons for sending as a “VOX member” or as a “New User.” Thus, the user can draft the message and then provide login/registration details upon the act of sending, rather than before.

As another example, although process 300 indicates that an anonymous message sent to a known recipient will identify the anonymous identifier of the sender, in certain embodiments this anonymous identifier can also be hidden. For example, the sender can select an option that hides this information from the recipient. According, in these embodiments the sent message will not have any information at all (anonymous or otherwise) about the sender. One of ordinary skill in the art will recognize many other variations, modifications, and alternatives.

In addition to facilitating interactive anonymous communication between users as described with respect to FIGS. 3A and 3B, certain embodiments of the present invention also enable a user to define a “microsite” for soliciting anonymous feedback. As used herein, a “microsite” is a web page or a collection of web pages that is meant to function as an auxiliary supplement to a primary website. In the context of the present invention, the microsites defined by users of system 112 can act as a feedback “portal” that allows visitors to enter anonymous messages/feedback regarding predefined topics. This feedback can then be viewed (and replied to) by the microsite author/administrator via the steps of FIG. 3B described above.

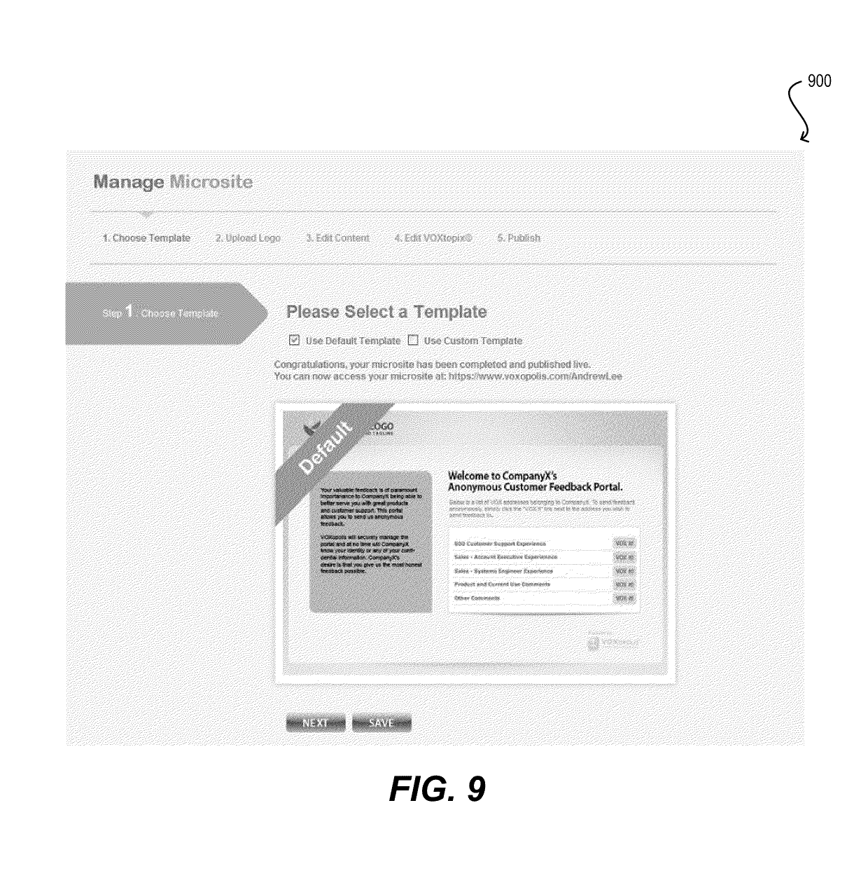

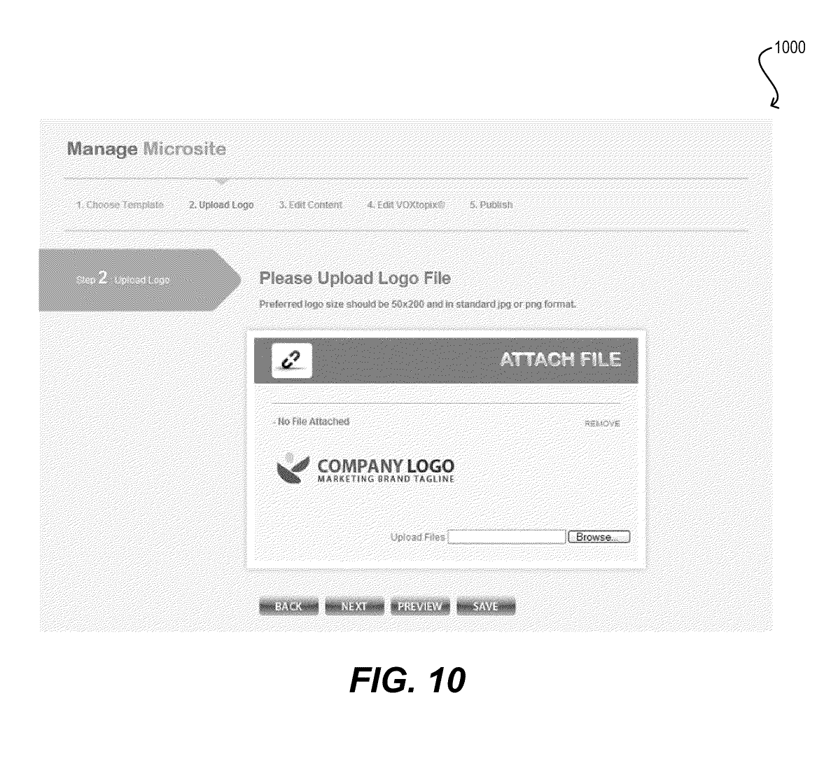

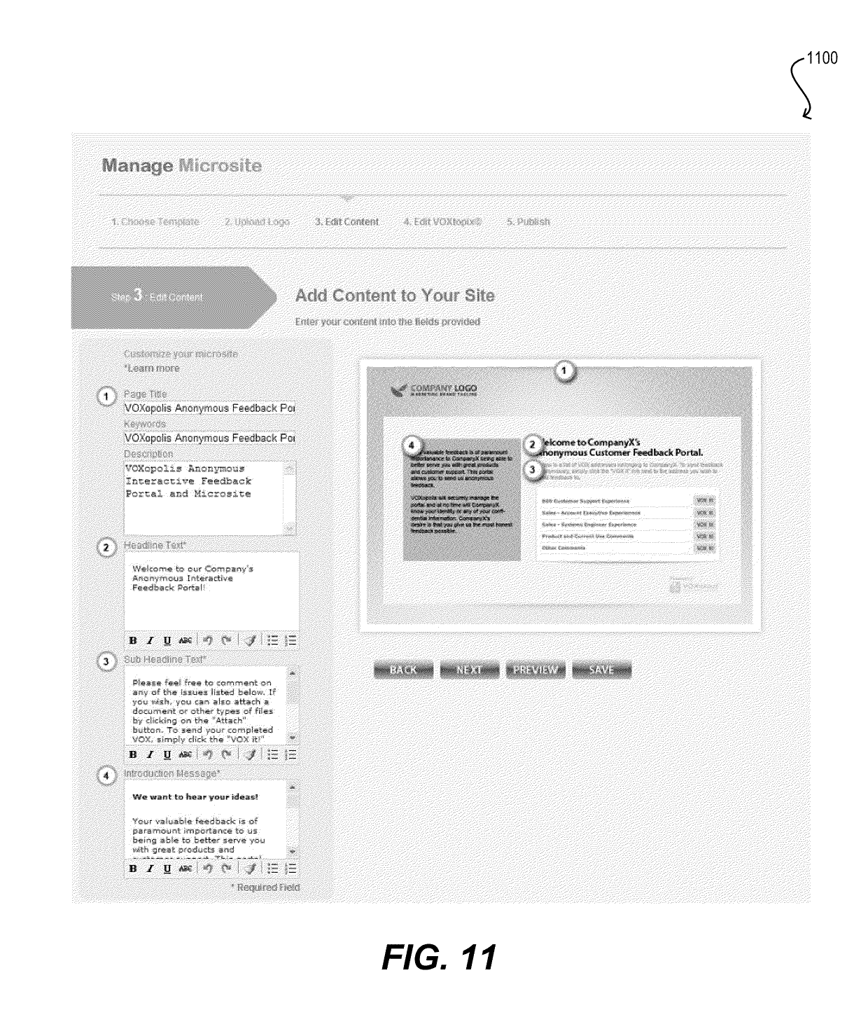

FIGS. 9-12 illustrate example user interfaces 900-1200 that can be generated by system 112 for defining a microsite according to an embodiment of the present invention. In user interface 900, a user can select a template for the layout of the microsite. As shown, the user can select from a default layout template or define a custom layout template. In user interface 1000, the user can select a company logo that will appear at the top of the microsite (e.g., if the microsite is used by a company to solicit customer/client feedback). In user interface 1100, the user can enter the text that will appear at various places on the microsite (e.g., page title, headline text, etc.). And in user interface 1200, the user can define the topics that visitors will be able to provide feedback for.

FIG. 1300 illustrates an example microsite 1300 that has been published by system 112. In one set of embodiments, microsite 1300 can be accessible via a URL that is a subdomain of the main domain of system 112. In another set of embodiments, microsite 1300 can be accessible via another URL that is unrelated to the domain of system 112. In a particular embodiment, the URL of microsite 1300 can include a sponsored top-level domain suffix (e.g., “.vox”) that has been dedicated for anonymous communication.

As shown in FIG. 1300, each topic (“Customer service,” “Product quality/defects,” and “Desired features for new products”) in the microsite can be associated with a user interface element (“VOX It!”) that enables visitors to send an anonymous message to the microsite author/administrator on that topic. For example, clicking on the “VOX It!” can cause a user interface window to pop up that is similar to message composition user interface 800 of FIG. 8. The visitor can then enter his/her message via the interface and send it through system 112. If the visitor is already a registered user of system 112, the system can prompt the visitor to login with his/her non-anonymous identifier and password prior to sending the message. If the visitor is not a registered user of system 112, the system can prompt to the visitor to enter registration information (and thus open a new account) prior to sending the message.

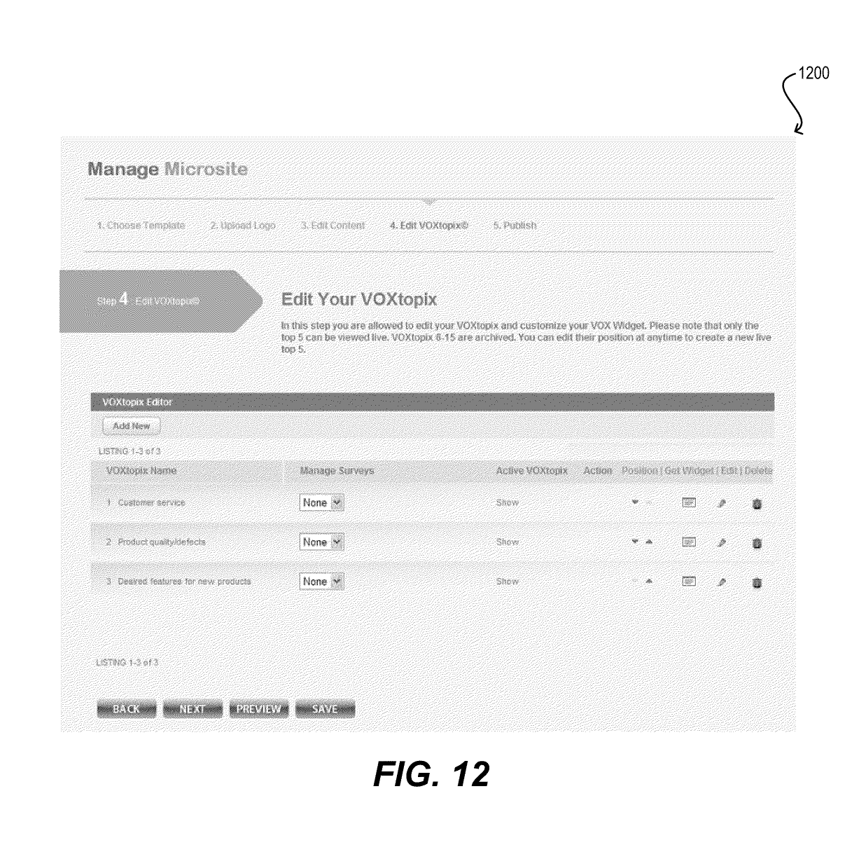

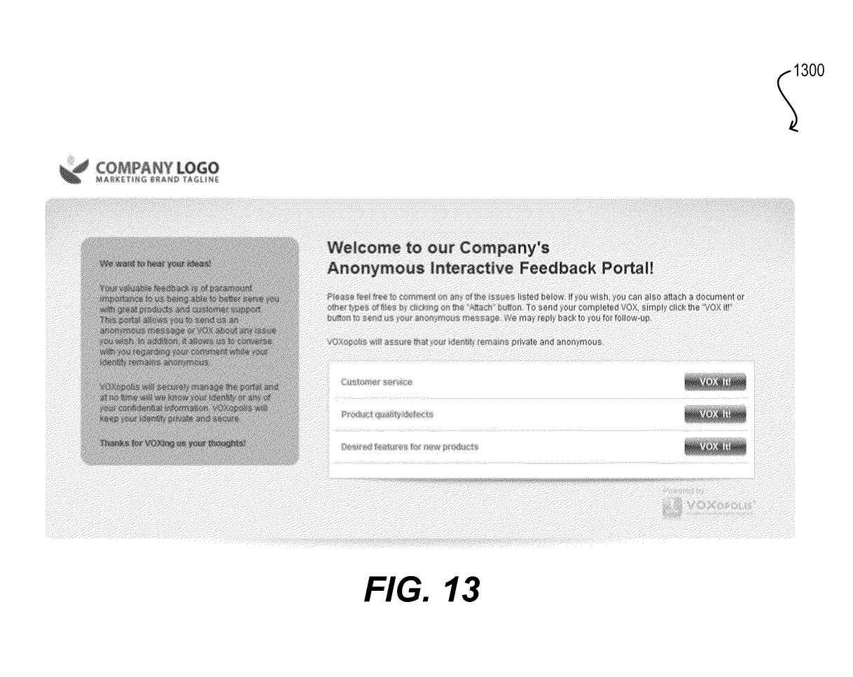

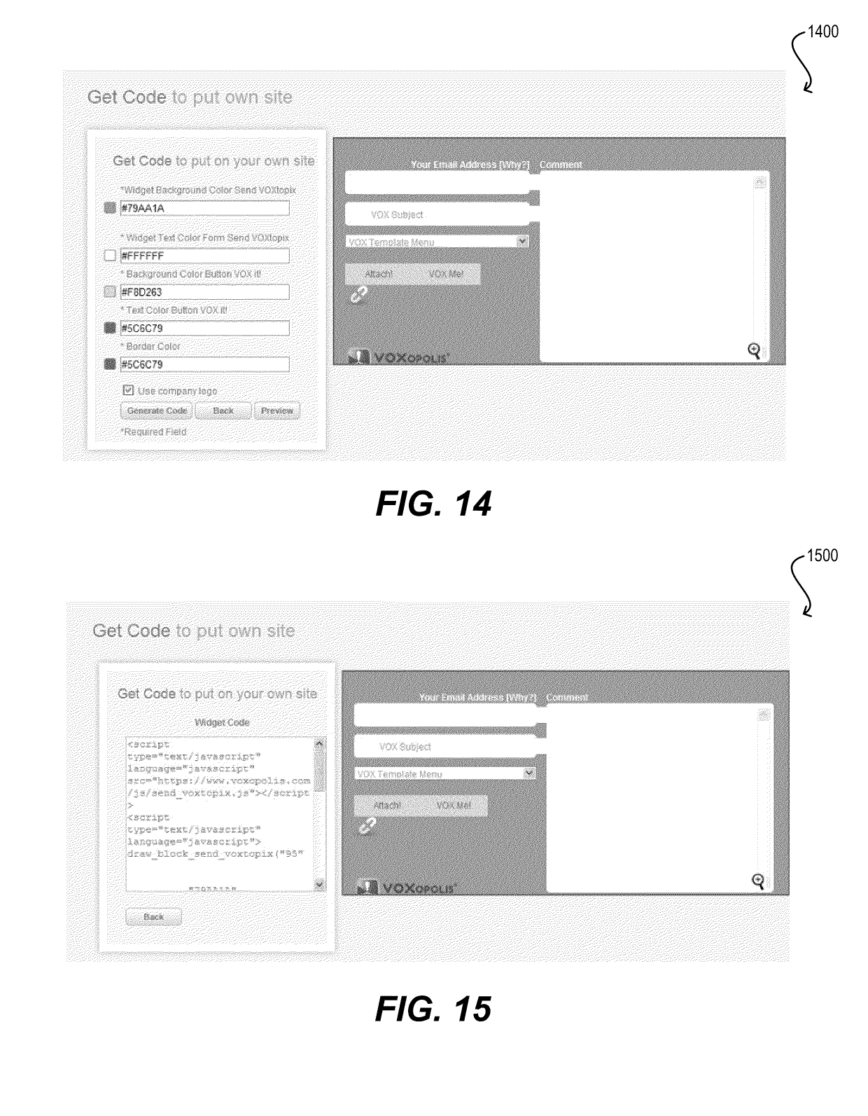

In one set of embodiments, each topic defined via user interface 1200 of FIG. 12 can also be captured in a “widget.” As used herein, a widget is essentially JavaScript code that can be embedded in any website and that renders a message composition user interface (similar to interface 800 of FIG. 8) for receiving anonymous feedback on the topic. When a visitor of the website enters a message via the message composition user interface, that data is relayed to system 112 and delivered to the widget author. FIGS. 14 and 15 illustrate example user interfaces 1400 and 1500 that show how a user can customize the appearance of the widget. Once its appearance has been finalized, the user can deploy the widget by copy and pasting the JavaScript code generated in user interface 1500 into the HTML source code of their website.

Although specific embodiments of the present invention are described above, it should be appreciated that various modifications, alterations, alternative constructions, and equivalents are within the scope of the invention. For instance, although certain embodiments are described as enabling anonymous interactive communication between two parties, the techniques described herein can be used to enable anonymous interactive communication between any number of parties. As one example, an anonymous sender can send an anonymous message to a group of known recipients, and any of the known recipients can reply to everyone while maintaining the anonymity of the original sender. As another example, an anonymous sender can send an anonymous message to a known recipient and copy a third party (that is known to the sender but anonymous to the recipient). The recipient can then reply to everyone while maintaining the anonymity of the original sender and the copied third party.

Further, although certain embodiments are described with respect to certain flow diagrams and steps, it should be apparent to those skilled in the art that the scope of the present invention is not limited to the described diagrams/steps.

Yet further, although certain embodiments are described using a particular combination of hardware and software, it should be recognized that other combinations of hardware and software are also within the scope of the present invention.

The specification and drawings are, accordingly, to be regarded in a illustrative rather than restrictive sense. It will be evident that additions, subtractions, and other modifications can be made thereunto without departing from the broader spirit and scope of the invention as set forth in the following claims.

What is claimed is:

1. A method comprising:
storing, by a computer system, account information for a plurality of users, the account information including anonymous identifiers for a first user and a second user and non-anonymous identifiers for the first user and the second user;
receiving, by the computer system, a first message from the first user, the first message being addressed from the anonymous identifier of the first user and being addressed to the non-anonymous identifier of the second user;
delivering, by the computer system, the first message to the second user;
receiving, by the computer system, a second message from the second user in response to the first message, the second message being addressed from the non-anonymous identifier of the second user and being addressed to the anonymous identifier of the first user; and
delivering, by the computer system, the second message to the first user.

2. The method of claim 1 wherein the delivered first message does not include the non-anonymous identifier of the first user or any other information revealing the identity of the first user.

3. The method of claim 1 wherein the delivered second message does not include the anonymous identifier of the second user.

4. The method of claim 1 further comprising:
receiving a third message from the second user, the third message being addressed from the anonymous identifier of the second user and being addressed to a non-anonymous identifier of a third user;
delivering the third message to the third user;
receiving a fourth message from the third user in response to the third message, the fourth message being addressed from a non-anonymous identifier of the third user and being addressed to the anonymous identifier of the second user; and
delivering the fourth message to the second user.

5. The method of claim 1 wherein delivering the first message to the second user comprises storing the first message in a message inbox maintained by the computer system for the second user, and wherein delivering the second message to the first user comprises storing the second message in a message inbox maintained by the computer system for the first user.

6. The method of claim 1 further comprising:
subsequently to delivering the first message, transmitting a delivery notification to an email address of the second user; and
subsequently to delivering the second message, transmitting a delivery notification to an email address of the first user.

7. The method of claim 1 further comprising, prior to receiving the first message from the first user:
generating a first user interface for authenticating the first user;
authenticating the first user based on information entered into the first user interface; and
generating a second user interface for enabling the first user to compose the first message.

8. The method of claim 7 wherein the second user interface includes a user interface control for searching for non-anonymous identifiers of other users.

9. The method of claim 7 wherein the second user interface includes a user interface control for selecting a pre-defined message template.

10. The method of claim 7 further comprising, subsequently to delivering the first message, generating a third user interface for enabling the first user to verify delivery of the first message.

11. The method of claim 10 further comprising, prior to receiving the second message from the second user:
generating a fourth user interface for authenticating the second user;
authenticating the second user based on information entered into the fourth user interface;
generating a fifth user interface for enabling the second user to view messages delivered to the second user; and
generating a sixth user interface for enabling the second user to compose the second message in response to the first message.

12. The method of claim 11 wherein the first, second, third, fourth, fifth, and sixth user interfaces are web-based interfaces.

13. The method of claim 11 wherein the first, second, third, fourth, fifth, and sixth user interfaces are rendered on a mobile device.

14. The method of claim 1 wherein the anonymous and non-anonymous identifiers of the first user are manually selected by the first user.

15. The method of claim 1 wherein the anonymous and non-anonymous identifiers of the first user are automatically determined by the computer system.

16. The method of claim 1 wherein the first message includes one or more of: text, a video clip, an audio clip, and an image.

17. The method of claim 1 further comprising:
generating a plurality of user interfaces for enabling the first user to define a microsite, the microsite including one or more topics and, for each topic, a user interface control for sending an anonymous message regarding the topic to the non-anonymous identifier of the first user.

18. The method of claim 17 wherein the microsite is accessible via a uniform resource locator (URL) that includes a domain name suffix dedicated to anonymous communication.

19. The method of claim 17 further comprising generating JavaScript code for a topic in the one or more topics that is embeddable in a web page, wherein the JavaScript code is configured to generate a user interface in the web page for enabling users to send an anonymous message regarding the topic to the non-anonymous identifier of the first user.

20. A non-transitory machine-readable storage medium having stored thereon program code executable by a computer system, the program code comprising:
code that causes the computer system to store account information for a plurality of users, the account information including anonymous identifiers for a first user and a second user and non-anonymous identifiers for the first user and the second user;
code that causes the computer system to receive a first message from the first user, the first message being addressed from the anonymous identifier of the first user and being addressed to the non-anonymous identifier of the second user;
code that causes the computer system to deliver the first message to the second user;
code that causes the computer system to receive a second message from the second user in response to the first message, the second message being addressed from the non-anonymous identifier of the second user and being addressed to the anonymous identifier of the first user; and
code that causes the computer system to deliver the second message to the first user.

21. A system comprising:
a storage device configured to store account information for a first user and a second user, the account information including anonymous identifiers for the first user and the second user and non-anonymous identifiers for the first user and the second user; and
a processor in communication with the storage device, the processor being configured to:
store account information for a plurality of users, the account information including anonymous identifiers for a first user and a second user and non-anonymous identifiers for the first user and the second user;
receive a first message from the first user, the first message being addressed from the anonymous identifier of the first user and being addressed to the non-anonymous identifier of the second user;
deliver the first message to the second user;
receive a second message from the second user in response to the first message, the second message being addressed from the non-anonymous identifier of the second user and being addressed to the anonymous identifier of the first user; and
deliver the second message to the first user.
